(19) United States
(12) Patent Application Publication
(10) Pub. No.: US 2026/0113580 A1
(43) Pub. Date: Apr. 23, 2026

(54) HEARING AID WITH HEARING AID MODULE, AND HEARING AID MODULE AND METHOD FOR MANUFACTURING THE SAME

(71) Applicant: Sivantos Pte. Ltd., Singapore (SG)

(72) Inventors: Kai Soon LOY, Singapore (SG); Wee Leng TAN, Singapore (SG); Eric GOMEZ SOLIS, Singapore (SG)

(21) Appl. No.: 19/352,684

(22) Filed: Oct. 8, 2025

(30) Foreign Application Priority Data
Oct. 17, 2024 (DE) 10 2024 210 081.1

(51) Int. Cl. H04R 25/00

(52) U.S. Cl. CPC H04R 25/609; H04R 2225/49

(57) ABSTRACT

A hearing aid module has a printed circuit board, at least one first electronics component, and a shield. The first electronics component is mounted on a top of the printed circuit board. The shield has a carrier material and a coating applied to the carrier material. The carrier material and the coating cover the first electronics component. The printed circuit board has at least one grounding layer exposed on a side surface of the printed circuit board. The coating is guided onto the side surface so that on the side surface, and the coating is electrically connected to the grounding layer. Furthermore, a hearing aid incorporates the hearing aid module and a method manufactures the hearing aid module.

### CROSS-REFERENCE TO RELATED APPLICATION

This application claims the priority, under 35 U.S.C. § 119, of German Patent Application DE 10 2024 210 081.1, filed Oct. 17, 2024; the prior application is herewith incorporated by reference in its entirety.

### FIELD AND BACKGROUND OF THE INVENTION

The invention relates to a hearing aid with a hearing aid module, and to such a hearing aid module and to a method for manufacturing the same.

One example of a hearing aid is a hearing assistive device used by a person suffering from decreased hearing ability. In most cases, such a hearing assistive device uses a microphone, that is, an electromechanical sound transducer, to convert an ambient sound to an electrical (audio/sound) signal so that the electrical signal is captured. The captured electrical signals are processed by means of an amplifier circuit and introduced into the person's auditory canal by means of a further electromechanical transducer in the form of a receiver. In most cases, processing of the captured sound signals is also carried out, for which a signal processor of the amplifier circuit is usually used. In this respect, the amplification is tuned to any hearing loss of the person.

A hearing aid typically also has multiple electronics components, e.g., the (sound) transducers mentioned above, the amplifier circuit, and the signal processor. These electronics components are part of a hearing aid module which is then disposed in a housing of the hearing aid and is protected from environmental influences in this way. The hearing aid module then also has, for example, a printed circuit board on which the individual electronics components are mounted and by means of which the electronics components are suitably electrically connected.

Since hearing aids are worn on the body of a human person, a small overall installation space is advantageous. To avoid being a burden in the day-to-day life of the person, hearing aids are correspondingly small in size and are provided with their own rechargeable or exchangeable voltage source.

In today's digital age, modern hearing aids are networked and regularly have means of communication with antennae to be incorporated into a radio network using common wireless, that is, cordless, connection types, such as, for instance, WLAN (wireless local area network) or Bluetooth. To guarantee a stable and error-free transfer function of the antenna of the hearing aid, it is desirable to electromagnetically shield other voltage-carrying electronics components of the hearing aid from the antenna. Aside from the shielding of an antenna, it is also desirable in principle to shield various electronics components from one another to ensure their proper functioning. Corresponding shielding advantageously avoids or at least reduces disturbance, especially electromagnetic interference, between the electronics components and, above all, also with the antenna, and thus ensures the respective electronic functions of all electronics components. This avoidance of disturbance, which also avoids the repetition of electronic sequences, advantageously also lowers the total energy consumption of the hearing aid and thus achieves a longer overall useful life.

Reference is made to U.S. patent publication No. 2023/0140748 A1, European patent application EP 3 755 127 A1 (corresponding to U.S. patent No. 12,171,058), and U.S. patent publication No. US 2021/036838 A1.

### SUMMARY OF THE INVENTION

A particular technical challenge and starting position for the present invention is to electromagnetically shield the respective electronics components, including an antenna, in particular, of a hearing aid from one another in a correspondingly small installation space. It is therefore an object of the invention to provide a hearing aid module which is improved in this regard. Further, a hearing aid with such a hearing aid module and a method for manufacturing the same are to be detailed.

According to the invention, regarding the hearing aid module, the object is attained by the features of the independent hearing aid module claim. Regarding the hearing aid, according to the invention, the object is attained by the features of the independent hearing aid claim. Regarding the method for manufacturing the hearing aid module, according to the invention, the object is attained by the features of the independent method claim. Advantageous further developments and adaptations are the subject matter of the dependent claims. The advantages and adaptations set forth with respect to the method are applicable analogously to the hearing aid module and the hearing aid, and vice versa.

With the foregoing and other objects in view there is provided, in accordance with the invention, a hearing aid module, including:
a. printed circuit board having a plurality grounding layers exposed on a side surface of the printed circuit board;
b. at least one first electronics component mounted on a top of the printed circuit board;
c. a shield having a carrier material and a coating applied to the carrier material, the carrier material and the coating cover the at least one first electronics component, wherein the coating is guided onto the side surface so that on the side surface, the coating is electrically connected to the at least one grounding layer;
d. the plurality of grounding layers are disposed one above another and electrically connected to the coating; and
e. the printed circuit board has at least one via by means of which at least two of the grounding layers are connected to one another, wherein the at least one via is cut and exposed on the side surface.

Here and in the following, a hearing aid module is understood to mean an electronic module which has at least one electronics component and is suitable for a hearing aid. A particularly suitable electronics component is, for instance, but is not limited to, an application-specific integrated circuit (ASIC), e.g., for realizing an amplifier circuit or a signal processor.

The hearing aid module according to the invention has a printed circuit board, at least one first electronics component, and a shield. The first electronics component is mounted, e.g., soldered, on a top of the printed circuit board. The shield has a carrier material, which is electrically insulating, in particular, and a coating, wherein the coating is applied to the carrier material. The carrier material thus carries the coating and similarly serves as a substrate for the coating. Preferably, the carrier material is an epoxy or an epoxy resin. In particular, the coating consists of an electrically conductive material, preferably metal, e.g., silver, gold, or silver-coated copper. In particular, the material for the coating is selected such that the coating adheres as well as possible to the carrier material and to the materials of the printed circuit board, especially to the grounding layer and other surfaces made of copper. This adhesion of the coating is achieved in particular during soldering, in particular reflow soldering. Moreover, the material for the coating is appropriately corrosion-resistant and weld-resistant. The carrier material and the coating cover the first electronics component (preferably completely), for electromagnetic shielding. As such, the shield realizes shielding of the first electronics component.

The printed circuit board has at least one grounding layer made of an electrically conductive material (e.g., copper) which is exposed on at least one side surface of the printed circuit board. In particular, “exposed” is understood to mean that the grounding layer extends within the printed circuit board up to its side surface and is then accessible on the side surface. In a particularly preferred adaptation, the grounding layer is exposed on all of the side surfaces of the printed circuit board. At the same time, the side surfaces of the printed circuit board form a circumferential contour of the printed circuit board. In addition to the side surfaces, the printed circuit board has the above-mentioned top, and a bottom opposite the top. Bottom and top are not understood to be side surfaces of the printed circuit board.

The grounding layer extends beneath the first electronics component and in particular within the printed circuit board, and thus additionally contributes to its electromagnetic shielding. For this reason, the grounding layer is also referred to as a shield layer. Appropriately, the printed circuit board also has a circuit layer disposed above the grounding layer, i.e., between the grounding layer and the first electronics component, and containing one or more traces for interconnecting the first electronics component, as appropriate, with other electronics components. In particular, the circuit layer is an uppermost layer of the printed circuit board, and is preferably disposed on its top. To connect the electronics component to other components outside the coating, the grounding layer appropriately has a local aperture through which a connection, starting from the first electronics component, leads through the grounding layer and to the bottom of the printed circuit board. In particular, one or more vias are then disposed in the aperture which are used to guide the traces of the circuit layer through the printed circuit board. Optionally, the printed circuit board has a further circuit layer on its bottom, which is then, as appropriate, connected to the circuit layer on the top using corresponding vias.

Now, the coating is guided onto the side surface, in particular preferably onto all of the side surfaces, of the printed circuit board and is electrically connected to the grounding layer so that electromagnetic shielding of the first electronics component is configured with respect to all spatial directions. The coating is thus not only applied to the carrier material, but immediately to the printed circuit board as well, more precisely to its side surface. The coating is thus in particular a continuous coating, i.e., it extends continuously both across the carrier material and across the side surface of the printed circuit board. As a result of the electrical connection of the grounding layer to the coating, the two of them are in particular at a common potential, namely grounding potential. Thus, by combining the coating and the grounding layer, the first electronics component is shielded entirely, i.e., in all directions.

In a preferred adaptation, the first electronics component is embedded in and encapsulated by the carrier material. Herein, the carrier material abuts the first electronics component immediately and/or without any gaps and surrounds it from all of its sides not mounted on the printed circuit board. As a result, the first electronics component is fixed in place particularly well, and good electromagnetic shielding is achieved. Preferably, the carrier material continues the printed circuit board seamlessly and/or steplessly on its top to the side surfaces and configures a step-free cuboid with the printed circuit board, which cuboid can then be coated homogeneously with the coating in a correspondingly simple manner.

The coating can be applied by spraying, splashing, vapor deposition, brushing, or immersion to achieve the lowest possible layer thickness. Preferably, the coating is configured as a spray coating which is easily applicable and scalable. The coating preferably has an average layer thickness in the range of from 1 μm to 20 μm, preferably from 10 μm to 12 μm, to enable a particularly small installation space for the hearing aid module. In principle, it would also be possible to utilize a shielding can as an alternative to the coating. However, the average layer thickness of the shielding would be significantly thicker than the coating described herein and would require its own fastening to or even outside of the printed circuit board. Both would disadvantageously increase the installation space requirement and costs in comparison with the coating mentioned.

In a preferred development, the grounding layer has at least one inverted corner. In other words and more generally, at least one of the corners of the grounding layer has a recess, i.e., conductive material is recessed in a corner region of the printed circuit board (i.e., where two side surfaces meet) in the plane of the grounding layer. In particular, the inverted corner is orthogonal and preferably has a leg length of 5 μm to 900 μm. Other shapes for the recess are possible in principle, but an inverted corner is particularly simple. The inverted corner is also referred to as an “inner corner.”

As a result of the recess, especially in the form of an inverted corner, the laterally exposed grounding layers precisely do not form any exposed outer corners made of conductive material in the corresponding corner region of the printed circuit board. As a result, burr-free separation of the printed circuit board (e.g., from a printed circuit board panel) is enabled during manufacture for the purpose of exposing the grounding layer and configuring the side surface. Preferably, all corners of the grounding layer are inverted. Thus, no corners of the grounding layer are exposed on the side surfaces of the printed circuit board, but only rectilinear sections which completely circumscribe the printed circuit board on its side surfaces with the exception of the recessed corners. Thus, when viewing the side surface, the then visible part of the grounding layer indeed does not extend along the entire side surface, but terminates at the corner region of the printed circuit board.

The printed circuit board has multiple grounding layers disposed one above the other, in particular in parallel to one another, and electrically connected to the coating. In particular, the printed circuit board has a number in the range of from two inclusive to twenty inclusive of such grounding layers. For the multiple grounding layers, the above statements concerning the at least one grounding layer apply analogously. In particular, each grounding layer is exposed on at least one side surface of the printed circuit board and is itself immediately connected to the coating. As a result, the total contact area between the grounding layers and the coating is increased, which in turn additionally advantageously increases the electromagnetic shielding of the first electronics component. In particular, all of the grounding layers along with the coating are then also at the same potential. In principle, it is preferred to expose as much conductive material as possible on the side surface to achieve particularly high conductivity when contacting the coating with the grounding layers. As described, this is possible due to as many grounding layers as possible, alternatively or additionally, however, also due to a configuration having as large a surface area as possible (particularly in the edge region of the printed circuit board) of a respective grounding layer such that it is exposed across as large a part of the side surface as possible.

The printed circuit board has one or more vias by means of which at least two of the grounding layers are directly electrically connected to one another. Preferably, all of the grounding layers are directly electrically connected to their respective directly adjacent grounding layers through at least one via so that all of the grounding layers are electrically connected to one another. Overall, a respective via is in particular cylindrical, that is, it has a circular cross-section when viewed in a plane parallel to the grounding layers, suitably with a diameter in the range of from 10 μm to 300 μm, preferably from 40 μm to 50 μm.

The one or more vias are cut and are also exposed on the side surface. In particular, the exposed vias are filled with an electrically conductive material, e.g., copper, so that a central cross-section of the via flat against the side surface between two exposed grounding layers is itself exposed. As a result, the total contact area between the vias and the coating is increased, which in turn additionally advantageously increases the electromagnetic shielding of the first electronics component. Moreover, the application of the coating is simplified during manufacture since recesses in the side surface are avoided so that in particular, this side surface is completely flat.

The exposed vias between two directly adjacent grounding layers are preferably offset with respect to one another along these grounding layers by a, preferably uniform, center-to-center spacing in the range of from 20 μm to 2000 μm. If an exposed grounding layer has upwardly exposed vias and downwardly exposed vias respectively to a directly adjacent grounding layer, preferably, the upper vias are offset with respect to the respective lower vias along the exposed grounding layer by a maximum spacing of up to half the center-to-center spacing so that an alternating sequence of exposed upper and lower vias is configured along an exposed grounding layer.

In one advantageous development, the hearing aid module has a motherboard on which the printed circuit board is mounted such that its top faces away from the motherboard. That is, the bottom of the printed circuit board opposite the top faces the motherboard. Now, the hearing aid module has a second electronics component disposed between the printed circuit board and the motherboard. The coating preferably terminates at the printed circuit board and is correspondingly not immediately connected to the motherboard. Preferably, the second electronics component is mounted on the bottom of the printed circuit board. Alternatively, the second electronics component is mounted on the motherboard or otherwise, it being essential, in particular, that the second electronics component is enclosed between the printed circuit board and the motherboard.

The printed circuit board and the motherboard are suitably connected by at least one electrically conductive connecting element. Typically, multiple such connecting elements are present. A respective connecting element appropriately establishes an electrical connection between the printed circuit board and the motherboard, e.g., a functionally relevant connection for electrical signal exchange. In addition, a respective connecting element also serves as a physical fastening means for fastening the printed circuit board to the motherboard.

In principle, any common and fitting printed circuit board connecting element is suitable as an electrically conductive connecting element, but a configuration of the connecting element as a solder ball is particularly preferred. Particularly preferred is a configuration with multiple solder balls configuring what is known as a ball grid array (BGA) and simultaneously at least partially surrounding the second electronics component. Thus, multiple connecting elements are then disposed in a grid-like manner or in the form of a matrix in multiple rows and columns. The second electronics component is embedded in the corresponding grid, for which purpose corresponding connecting elements are left blank in the grid. This enables a fitting installation space for the second electronics component between the printed circuit board and the motherboard and allows a connecting element density between the printed circuit board and the motherboard which is easy to accomplish and high.

Preferably, one or more, but not necessarily all, connecting elements serve to carry the ground potential, i.e., are electrically connected to the grounding layers and the coating. In the case of solder balls, these connecting elements, which in the operating state carry the electrical ground potential, that is, the same electrical potential as the grounding layer and the via, are referred to as ground balls. These ground balls are distributed across the bottom of the printed circuit board and are preferably positioned at least at outer corners of the ball grid array and/or near the corner regions of the printed circuit board. As a result, the second electronics component is advantageously electromagnetically shielded since it is at least partially surrounded from above by the grounding layer of the printed circuit board, from below by a grounding layer of the motherboard, and to its sides by the ground balls. Herein and also generally, the terms “above” and “below” are to be understood with reference to the top and bottom of the printed circuit board. That is, “below” is to be understood to mean a spatial direction which, starting from the second electronics component, faces the motherboard, and “above” is to be understood to mean a spatial direction which, starting from the second electronics component, faces the printed circuit board.

In an appropriate adaptation, the hearing aid module has an antenna which serves, in particular during operation of the hearing aid, for transmitting and/or receiving an electromagnetic signal. The antenna is an electronics component. In particular, the antenna is suitable for transmitting and/or receiving in a radio network and/or a part of a communication unit of the hearing aid module. Alternatively or additionally, the antenna is suitable for wireless energy absorption, i.e., for an inductive charging procedure of the hearing aid. An antenna suitable for a plurality of functions is also conceivable. Due to the shield, the first electronics component is electromagnetically shielded from the antenna.

Preferably, the antenna is mounted at a different location on the motherboard than the printed circuit board. The respective electromagnetic shielding of the first and/or second electronics components avoids any electromagnetic interference between the electronics components and/or any electromagnetic interference with the antenna of the respective electronics component and/or any electromagnetic interference from any combination of the aforementioned components. In this respect, it is irrelevant what the origin of the electromagnetic interference is. The respective electromagnetic shielding is suitable for shielding incoming and/or outgoing electromagnetic spurious signals from and/or to the respective electronics component.

The statements in connection with the antenna also apply analogously to an adaptation with any electronics component instead of or in addition to the antenna.

Particularly preferably, the first electronics component is configured as an ASIC. For example, the electronics component is the previously mentioned signal processor or the previously mentioned amplifier circuit. In principle, however, the electronics component can also be any other component, e.g., a simple component such as a capacitor, a resistor, an inductance, an oscillator (crystal), or the like, or a complex component such as an RF chip, a power management IC, or the previously mentioned ASIC. Each of these components can emit potentially spurious electromagnetic radiation, but particularly the RF chip mentioned, for which a shield is then particularly appropriate.

The invention also comprises a hearing aid with a hearing aid module as described above. For example, the hearing aid is an earphone, a hearable, or a headset, or a system therewith. Particularly preferably, however, the hearing aid is a hearing assistive device. The hearing assistive device is for assisting a person (user of the hearing aid) suffering from decreased hearing ability (hearing deficit). In operation, the hearing aid then compensates for hearing loss of the person. Such a hearing assistive device generally has an input transducer, a signal processor, and an output transducer. The input transducer is usually a microphone. The output transducer is usually a receiver which is also referred to as a loudspeaker. The hearing assistive device is regularly assigned to and only used by an individual user and serves to compensate for, in particular, individual hearing loss of this user. The input transducer generates an input signal which is supplied to the signal processor. The latter modifies the input signal and thereby generates an output signal. To compensate for the hearing loss, the input signal is amplified with a frequency-dependent amplification factor according to an audiogram of the user. The output signal is finally output to the user by means of the output transducer. In a hearing assistive device with a microphone and a receiver, the microphone correspondingly generates the input signal from sound signals in the environment, and the receiver generates a sound signal from the output signal again. The input signal and the output signal are electrical signals. The hearing assistive device is, for example, a “receiver-in-the-canal” hearing assistive device (RIC; ex-receiver hearing assistive device), a hearing assistive device inside the ear, such as an “in-the-ear” hearing assistive device, an “in-the-canal” (ITC) hearing assistive device, or a “completely-in-canal” (CIC) hearing assistive device, a pair of hearing glasses, a pocket hearing assistive device, a bone conduction hearing assistive device, an implant, a “behind-the-ear” hearing assistive device, or the like.

Furthermore, the invention comprises a method for manufacturing a hearing aid module as described above. The method has a first method step in which at least one grounding layer is exposed by separating, in particular cutting, the printed circuit board from a printed circuit board panel along a singulation contour, e.g., a cutting line. In particular, this method step is also referred to as “dicing.” The printed circuit board panel has at least one printed circuit board, but typically multiple printed circuit boards, to separate as many printed circuit boards as possible along their respective singulation contours. The printed circuit boards and their layers (grounding layers and circuit layers) are first manufactured together as a printed circuit board panel and then subsequently singulated.

In particular, in the first method step, i.e., during separating, not only at least one grounding layer is exposed, but also at least one via. In this respect, the grounding layer and/or the via protrude beyond the singulation contour so that separating, in particular cutting, along the singulation contour separates the respective protruding part and exposes the respective separating surface on the side of the printed circuit board. Particularly preferably, half of the via protrudes beyond the singulation contour so that the separating exposes a separating surface of the via having a maximum size.

In particular, in the first method step, the advantage mentioned further above of the recess, especially the inverted corner, is also realized, i.e., the printed circuit board is separated free of burrs.

The method comprises a further, second method step in which the coating is applied. Simultaneously, the coating is also electrically connected to the grounding layer of the printed circuit board. Preferably, the coating is not only connected to the grounding layer of the printed circuit board, but also to the via of the printed circuit board. In particular, the coating is connected to all of the exposed grounding layers and vias of the printed circuit board. It is also apparent from the statements above that the second method step (coating) is necessarily carried out after the first method step (separating) since the side surface of the printed circuit board, to which the coating is also to be applied after all, is not configured until the separating.

Other features which are considered as characteristic for the invention are set forth in the appended claims.

Although the invention is illustrated and described herein as embodied in a hearing aid with hearing aid module, and a hearing aid module and a method for manufacturing the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a simplified, schematic cross-sectional view of a portion of a hearing aid module;

FIG. 2 is a simplified, schematic cross-sectional view of a hearing aid;

FIG. 3 is a side-view photograph of a real-world printed circuit board with a carrier material;

FIG. 4 is a simplified, schematic top view of a corner region of a grounding layer;

FIG. 5 is a photograph of two real-world separated printed circuit boards;

FIG. 6 is a simplified, schematic top view of a printed circuit board on its bottom;

FIG. 7 is a simplified, schematic cross-section of a portion of a printed circuit board panel; and

FIG. 8 is a simplified, schematic cross-sectional view of the printed circuit board.

Corresponding parts and sizes are provided with the same reference symbols throughout the figures.

### DETAILED DESCRIPTION OF THE INVENTION

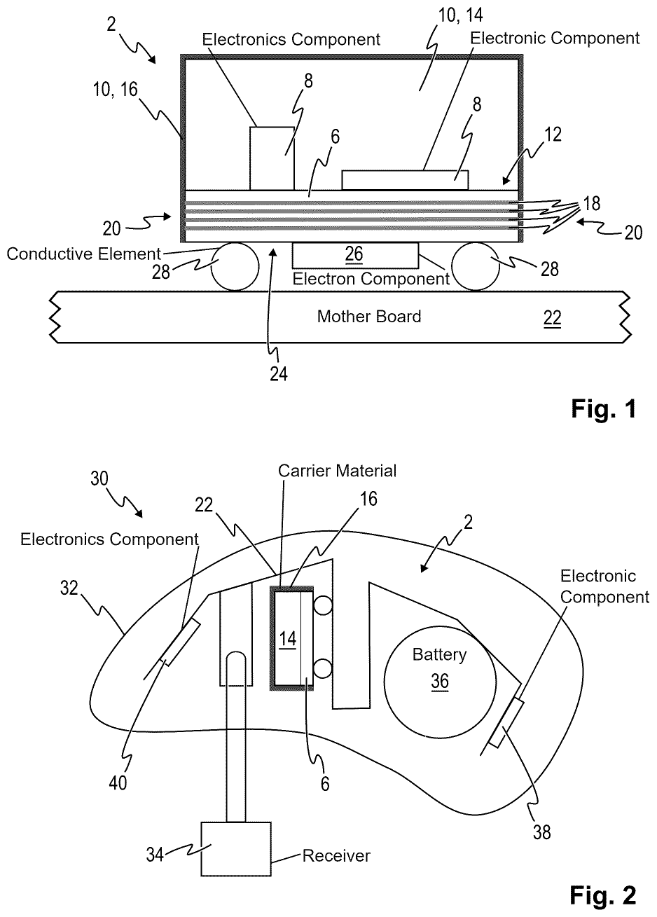

Referring now to the figures of the drawings in detail and first, particularly to FIG. 1 thereof, there is shown a schematic cross-sectional view of a portion of a hearing aid module 2. The latter has a printed circuit board 6, at least one first electronics component 8, herein exactly two first electronics components 8, and a shield 10. The first electronics component 8 is an ASIC, for instance. The two first electronics components 8 are mounted on a top 12 of the printed circuit board 6. The shield 10 has an electrically insulating carrier material 14 and a coating 16, wherein the coating 16 is applied to the carrier material 14. The carrier material 14 carries the coating 16. Presently, the coating 16 consists of an electrically conductive material. The carrier material 14 and the coating 16 cover the first electronics components 8 completely, for electromagnetic shielding. As such, the shield 10 realizes shielding of the first electronics components 8.

The printed circuit board 6 has at least one grounding layer 18 made of an electrically conductive material which is exposed on at least one side surface 20 of the printed circuit board 6. Herein, “exposed” is understood to mean that the grounding layer 18 extends within the printed circuit board 6 up to its side surface 20 and is then accessible on the side surface 20. In FIG. 1, the printed circuit board 6 has multiple, herein specifically four, grounding layers 18 disposed one above the other and also in parallel to one another and electrically connected to the coating 16. Each grounding layer 18 is exposed on at least one side surface 20 of the printed circuit board 6 and is itself immediately electrically connected to the coating 16. The grounding layers 18 extend beneath the first electronics components 8 and within the printed circuit board 6, and thus additionally contribute to their electromagnetic shielding.

In FIG. 1, the coating 10 is guided onto all of the side surfaces 20 of the printed circuit board 6 and is electrically connected to the grounding layers 18 so that electromagnetic shielding of the first electronics components 8 is configured with respect to all spatial directions. The coating 16 is thus not only applied to the carrier material 14, but immediately to the printed circuit board 6 as well, more precisely to its side surfaces 20. The coating 16 is thus in particular a continuous coating 16, i.e., it extends continuously both across the carrier material 14 and across the side surfaces 20 of the printed circuit board 6. As a result of the electrical connection of the grounding layers 18 to the coating 16, they are at a common potential, namely grounding potential. Thus, by combining the coating 16 and the grounding layers 18, the first electronics components 8 are shielded entirely, i.e., in all directions.

In the exemplary embodiment of FIG. 1, the first electronics components 8 are embedded in and encapsulated by the carrier material 14. Herein, the carrier material 14 abuts the first electronics components 8 immediately and without any gaps and surrounds them from all of their sides not mounted on the printed circuit board 6. As a result, the first electronics components 8 are fixed in place, and electromagnetic shielding is achieved. Herein, the carrier material 14 continues the printed circuit board 6 seamlessly and steplessly on its top 12 to the side surfaces 20 and configures a step-free cuboid with the printed circuit board 6, which cuboid can then be, and is, coated homogeneously with the coating 16 in a correspondingly simple manner. The coating 16 can be applied by spraying, splashing, vapor deposition, brushing, or immersion to achieve a low layer thickness. Presently, the coating 16 is configured as a spray coating.

The hearing aid module 2 shown by way of example herein has a motherboard 22 on which the printed circuit board 6 is mounted such that its top 12 faces away from a motherboard 22. That is, a bottom 24 of the printed circuit board 6 opposite the top 12 faces the motherboard 22. Herein, the hearing aid module 2 has a second electronics component 26 disposed between the printed circuit board 6 and the motherboard 22 and mounted on the bottom 24 of the printed circuit board 6. Herein, the second electronics component 26 is thus enclosed between the printed circuit board 6 and the motherboard 22. The coating 16 terminates at the printed circuit board 6 and is correspondingly not immediately connected to the motherboard 22.

In the exemplary embodiment of FIG. 1, the printed circuit board 6 and the motherboard 22 are connected by at least one, herein multiple, electrically conductive connecting elements 28. A respective connecting element 28 serves as a physical fastening means for fastening the printed circuit board 6 to the motherboard 22 and optionally also establishes an electrical connection between the printed circuit board 6 and the motherboard 22.

FIG. 2 shows a schematic cross-section of a hearing aid 30, herein exemplarily a “receiver-in-the-canal” hearing assistive device (RIC; ex-receiver hearing assistive device). The hearing aid module 2 is enveloped by a housing 32, wherein a receiver 34 is guided outwards. The hearing aid module 2 has a voltage source 36, herein a battery, and a third electronics component 38 and a fourth electronics component 40. Herein, the third electronics component 38 is configured as an antenna. Thus, the first electronics component 8 is shielded from the antenna due to the shield 10. Depending on the adaptation, the number of electronics components 8, 26, 36, 38, 40 and their adaptations may vary.

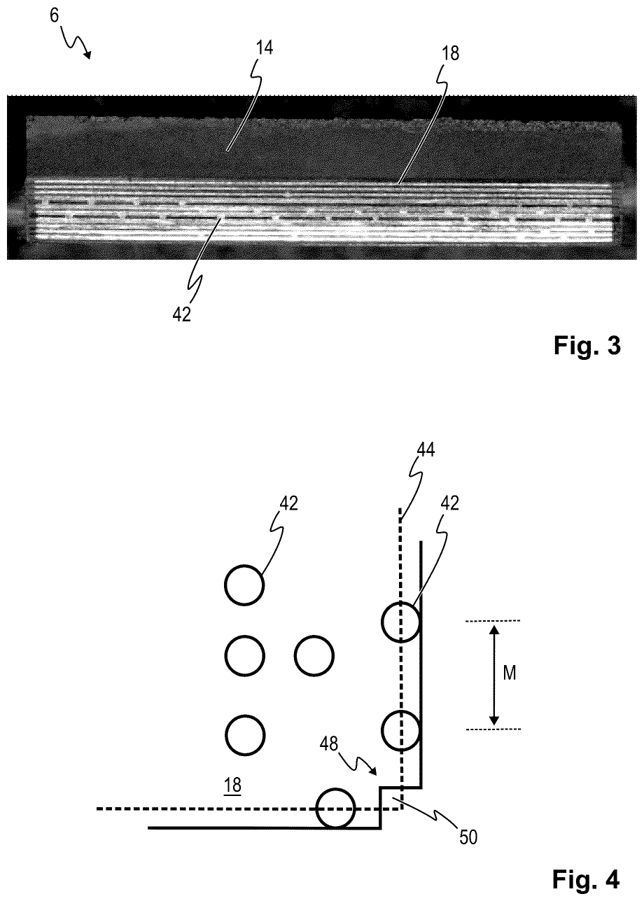

FIG. 3 shows a side-view photograph of a real-world printed circuit board 6 with a carrier material 14 with a clear view of a side surface 20. The individual laterally exposed grounding layers 18 and the cut, and as a result likewise exposed, vias 42 are particularly easy to identify herein. For the sake of clarity, these are each provided with only one reference symbol in the photograph, although they are present multiple times. In particular, ten exposed grounding layers 18 are present herein. The photograph shows the printed circuit board 6 with the carrier material 14 after the respective grounding layers 18 and the respective vias 42 have been exposed by separating, but before the coating 16 has been applied.

The hearing aid module 2 is manufactured according to a method in which in a first method step (separating), at least one grounding layer 18 is exposed by separating the printed circuit board 6 from a printed circuit board panel 46 along a singulation contour 44. In a second method step (coating), the coating 10 is then applied and simultaneously, it is electrically connected to the grounding layer 18. That is, the photograph in FIG. 3 has been taken between the first and the second method steps.

Herein, the printed circuit board 6 has multiple vias 42 by means of which at least two of the grounding layers 18 are directly electrically connected to one another. In one possible adaptation, all of the grounding layers 18 are directly electrically connected to their respective directly adjacent grounding layers 18 through at least one via 42 so that all of the grounding layers 18 are electrically connected to one another. Above all, this can also be realized with vias 42 located further inward, which are not identifiable in FIG. 3. The exposed vias 42 are filled with an electrically conductive material so that a central cross-section of the via 42 flat against the side surface 20 between two exposed grounding layers 18 is itself exposed. As appropriate, multiple vias are stacked one above the other as shown.

FIG. 4 shows a simplified schematic top view of a corner region of a grounding layer 18 before the first method step which is also referred to as “dicing.” The printed circuit board panel 46 has at least one printed circuit board 6, but typically multiple printed circuit boards 6, to separate as many printed circuit boards 6 as possible along their respective singulation contours 44. The printed circuit boards 6 and their layers (grounding layers 18 and circuit layers) are first manufactured together as a printed circuit board panel 46 and then subsequently singulated. In particular, in the first method step, i.e., during separating, not only at least one grounding layer 18 is exposed, but also at least one via 42 (in FIG. 4, three vias 42). In this respect, as discernible in FIG. 4, the grounding layer 18 and/or the via 42 protrude beyond the singulation contour 44 so that separating along the singulation contour 44 separates the respective protruding part and exposes the respective separating surface on the side surface 20 of the printed circuit board 6. In the exemplary embodiment of FIG. 4, half of the vias 42 protrude beyond the singulation contour 44 so that the separating exposes a separating surface of the via 42 having a maximum size.

The exposed vias 42 between two directly adjacent grounding layers 18 can be offset with respect to one another by a center-to-center spacing M. If an exposed grounding layer 18 has upwardly exposed vias 42 and downwardly exposed vias 42 respectively to a directly adjacent grounding layer 18, for example, the upper vias 42 are offset with respect to the respective lower vias 42 along the exposed grounding layer 18 such that an alternating sequence of exposed upper and lower vias 42 is configured along an exposed grounding layer 18. This is particularly easy to identify in FIG. 3.

Herein, in the exemplary embodiment shown, the grounding layer 18 in FIG. 4 has an inverted corner 48. More generally, at least one of the corners of the grounding layers 18 has a recess 50, i.e., conductive material is recessed in a corner region of the printed circuit board 6 (i.e., where two side surfaces 20 meet) in the plane of the grounding layer 18. This is also easily identifiable in FIG. 3. The inverted corners 48 shown herein exemplarily are orthogonal. As a result of the recess 50, especially in the form of an inverted corner 48, the laterally exposed grounding layer 18 precisely does not form any exposed outer corner of conductive material in the corresponding corner region of the printed circuit board 6, which is why during manufacture, burr-free dividing for the purpose of exposing the grounding layer 18 and configuring the side surface 20 is enabled.

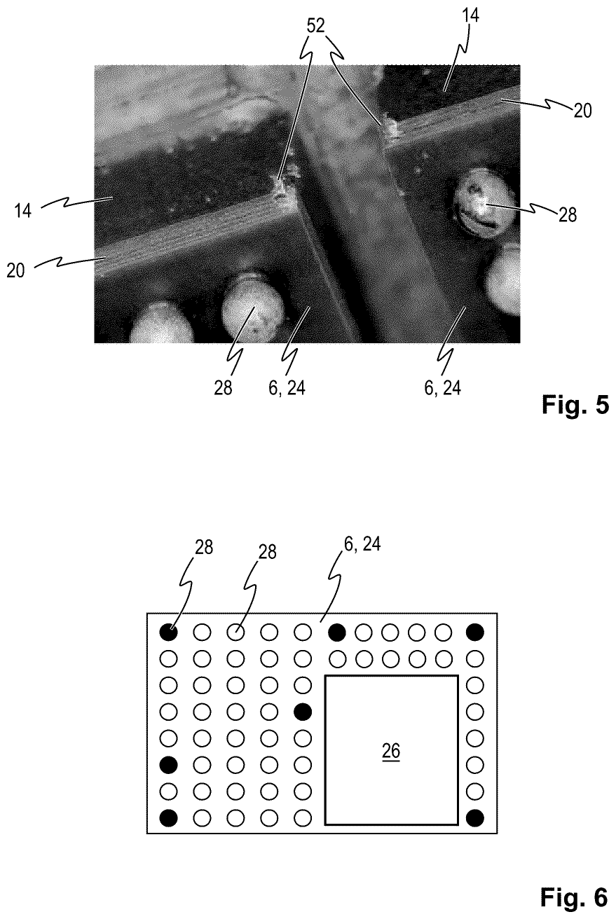

This is illustrated in FIG. 5, which shows a photograph of two real-world printed circuit boards 6 after being separated from a printed circuit board panel 46, wherein the respective grounding layers 18 do not have any inverted corners 48 and generally do not have any recesses 50. Correspondingly, a burr 52 results in the corner region of the printed circuit board 6 during separating. Such a burr 52 would impede the ensuing application of the coating 16 and prevent continuous and homogeneous application of the coating 16. In principle, such a burr 52 can also be tolerated and subsequently be removed so that the recesses 50 mentioned are not necessarily required.

If all of the corners of the grounding layer 18 are inverted, no corners of the grounding layer 18 are exposed on the side surfaces 20 of the printed circuit board 6, but only rectilinear sections which completely circumscribe the printed circuit board 6 on its side surfaces 20 with the exception of the recessed corners. Thus, when viewing the side surface 20, the then visible part of the grounding layer 18 indeed does not extend along the entire side surface 20, but terminates at the corner region of the printed circuit board 6. This is particularly easy to identify in FIG. 3.

FIG. 6 shows a simplified schematic top view of the bottom 24 of a printed circuit board 6 in which the connecting elements 28 are configured as a ball grid array (BGA) and at least partially surround the second electronics component 26. Thus, multiple connecting elements 28 are then disposed in a grid-like manner or in the form of a matrix in multiple rows and columns. This enables a fitting installation space for the second electronics component 26 between the printed circuit board 6 and the motherboard 22. One or more, but not necessarily all, connecting elements 28 serve to carry the ground potential, i.e., are electrically connected to the grounding layers 18 and the coating 16. In the case of solder balls, these connecting elements 28, which in the operating state carry the electrical ground potential, that is, the same electrical potential as the grounding layer 18 and the via 42, are referred to as ground balls. These ground balls are distributed across the bottom 24 of the printed circuit board 6 and are preferably positioned at least at outer corners of the ball grid array and/or near the corner regions of the printed circuit board 6. FIG. 6 depicts those connecting elements 28 as fully filled. The number and arrangement of these connecting elements 28 connected to the ground potential can vary.

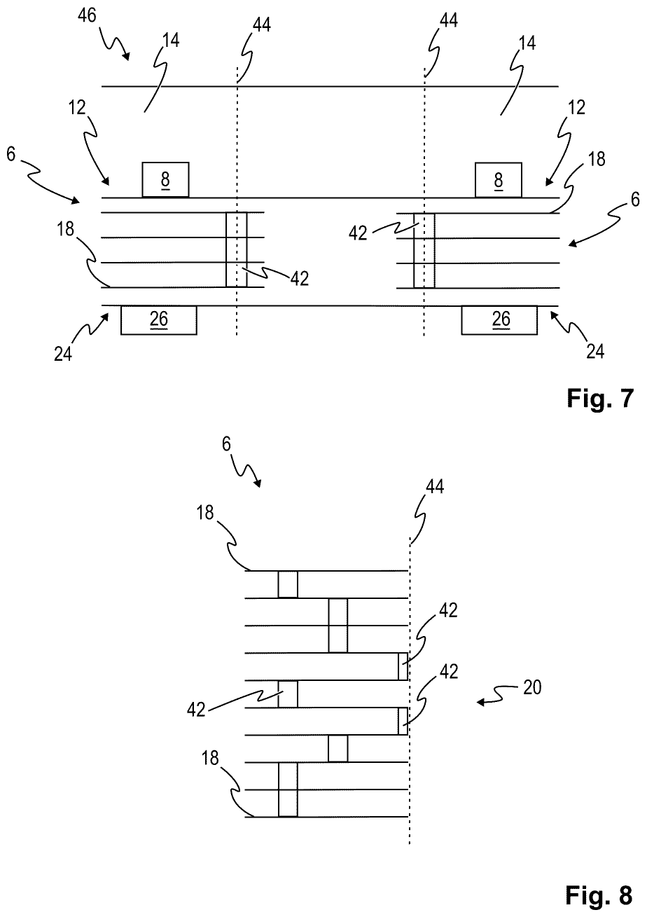

FIG. 7 shows a simplified and schematic cross-section of a portion of a printed circuit board panel 46 before the first method step. Herein, the vias 42 and grounding layers 18 protruding beyond the singulation contour 44, which will be exposed on the side surface 20 after the first method step, are easy to identify. Any circuit layers above and below the stack of grounding layers 18 for attaching the electronics components 8, 26 are not explicitly depicted. In fact, the coating 16 is not yet present in FIG. 7, with only the carrier material 14 already applied.

FIG. 8 shows a simplified and schematic cross-section of a printed circuit board 6 after the first method step. The vias 42 on the side surface 20 exposed by means of the first method step are easy to identify. However, non-exposed vias 42, which extend within the printed circuit board 6 and there electrically connect the individual grounding layers 18 to one another, are also easy to identify.

The following is a summary list of reference numerals and the corresponding structure used in the above description of the invention:
2 Hearing aid module
6 Printed circuit board
8 First electronics component
10 Shield
12 Top
14 Carrier material
16 Coating
18 Grounding layer
20 Side surface
22 Motherboard
24 Bottom
26 Second electronics component
28 Connecting element
30 Hearing aid
32 Housing
34 Receiver
36 Voltage source
38 Third electronics component (antenna)
40 Fourth electronics component
42 Via
44 Singulation contour
46 Printed circuit board panel
48 Inverted corner
50 Recess
52 Burr
M Center-to-center spacing

1. A hearing aid module (2),
a. having a printed circuit board (6), at least one first electronics component (8), and a shield (10),
b. wherein the first electronics component (8) is mounted on a top (12) of the printed circuit board (6),
c. wherein the shield (10) has a carrier material (14) and a coating (16) applied to the carrier material (14),
d. wherein the carrier material (14) and the coating (16) cover the first electronics component (8),
e. wherein the printed circuit board (6) has at least one grounding layer (18) exposed on a side surface (20) of the printed circuit board (6),
f. wherein the coating (16) is guided onto the side surface (20) so that on the side surface (20), the coating (16) is electrically connected to the grounding layer (18),
g. wherein the printed circuit board (6) has multiple grounding layers (18) disposed one above the other and electrically connected to the coating (16),
h. wherein the printed circuit board (6) has one or more vias (42) by means of which at least two of the grounding layers (18) are connected to one another,
i. wherein the one or more vias (42) are cut and are also exposed on the side surface (20).

2. The hearing aid module (2) of claim 1,
wherein the first electronics component (8) is embedded in and encapsulated by the carrier material (14).

3. The hearing aid module (2) of claim 1 or 2,
wherein the coating (16) is a spray coating.

4. The hearing aid module (2) of any one of claims 1 to 3,
wherein the grounding layer (18) has at least one inverted corner (48).

5. The hearing aid module (2) of any one of claims 1 to 4,
wherein all of the grounding layers (18) are connected by means of the one or more vias (42).

6. The hearing aid module (2) of any one of claims 1 to 5,
having a motherboard (22) on which the printed circuit board (6) is mounted such that its top (12) faces away from the motherboard (22),
having a second electronics component (26) disposed between the printed circuit board (6) and the motherboard (22),
wherein the printed circuit board (6) and the motherboard (22) are connected by at least one electrically conductive connecting element (28).

7. The hearing aid module (2) of claim 6,
wherein multiple electrically conductive connecting elements (28) form a ball grid array at least partially surrounding the second electronics component (26).

8. The hearing aid module (2) of any one of claims 1 to 7,
having an antenna,
wherein the first electronics component (8) is shielded from the antenna due to the shield (10).

9. The hearing aid module (2) of any one of claims 1 to 8,
wherein the first electronics component (8) is an integrated circuit.

10. A hearing aid (30) with a hearing aid module (2) according to any one of claims 1 to 9.

11. A method for manufacturing a hearing aid module (2) according to any one of claims 1 to 9,
a. wherein the at least one grounding layer (18) is exposed by separating the printed circuit board (6) from a printed circuit board panel (46) along a singulation contour (44),
b. wherein the coating (16) is applied and simultaneously, the coating (16) is electrically connected to the grounding layer (18).

12. The method of claim 11,
wherein the at least one grounding layer (18) is exposed by cutting the printed circuit board (6) from the printed circuit board panel (46) along the singulation contour (44).
